(19) United States
(12) Patent Application Publication
(10) Pub. No.: US 2013/0270886 A1
(43) Pub. Date: Oct. 17, 2013

(54) INTERIOR STRUCTURE OF AUTOMOBILE HAVING A LEG REST AT THE FRONT PASSENGER SEAT

(71) Applicant: Austin Kim, Fresh Meadows, NY (US)

(72) Inventor: Austin Kim, Fresh Meadows, NY (US)

(21) Appl. No.: 13/532,682

(22) Filed: Jun. 25, 2012

(30) Foreign Application Priority Data
Apr. 16, 2012 (KR) 10-2012-0038940

(51) Int. Cl. B60N 2/44

(52) U.S. Cl. 297/423.1

(57) ABSTRACT

Disclosed is an interior structure of an automobile in which the dashboard is not substantially installed before the front passenger seat and after the partition separating the engine room from the interior room of the automobile to obtain a sufficient space for the front passenger to stretch out her or his legs horizontally and completely; therefore a leg rest is installed in the obtained space. The automobile interior structure in accordance with the present invention make the front passenger unfold the leg rest continuously to the front passenger seat when she or he takes a rest and therefore make the front passenger stretch out her or his legs horizontally and completely to take a more comfortable rest.

### CROSS REFERENCES

Applicant claims foreign priority under Paris Convention to Korean Patent Application No. Application No. 10-2012-0038940 filed on Apr. 16, 2012, with the Korean Intellectual Property Office, where the entire contents are incorporated herein by reference.

### BACKGROUND OF THE INVENTION

This invention relates to an interior structure of automobile having a leg rest at the front passenger seat in which a sufficient space is provided in front of the front passenger seat to unfold widely the leg rest continuously to the front passenger seat, and therefore a passenger sitting on the front passenger seat may stretch out her or his legs completely and horizontally to feel comfortable in her or his rest.

An automobile is basically used to move a long distance rapidly and also has several pieces of convenient equipment to provide more comfortable feelings for the passengers during its running and stopping. The driver seat and the front passenger seat are tilted to the back in a range to almost 180 degree so that the driver and the passenger may take a comfortable rest. Such structures of the driver seat and the front passenger seat make the driver and the passenger take a posture of lying down on the seats to feel comfortable. However, when the passenger take a posture of lying down on the seats, the passenger shall still put her or his feet on the automobile interior bottom and therefore feels uncomfortable in her or his legs and feet. When the passenger put her or his feet down on the front passenger seat dashboard or lies curled up on the seat, she or he may obtain a little comfortable feeling, but it is not a fundamental comfortable feeling.

To remove such uncomfortable feelings, suggestions to install foot rests or leg rests in front of the front passenger seat have disclosed. Such suggestions may be found in Korean Utility Model Laid-Open Publication No. 20-2000-0012181, Korean Patent Laid-Open Publication No. 10-2001-0068093, Korean Utility Model Registration No. 20-0300112, Korean Utility Model Registration No. 20-0238671, Korean Utility Model Laid-Open Publication No. 20-1998-024167, Korean Patent Laid-Open Publication No. 10-1997-0036987, Korean Patent Registration No. 10-0666277, Korean Utility Model Registration No. 20-0152225, Korean Patent Laid-Open Publication No. 10-1999-019963, Korean Utility Model Registration No. 20-0147896, Korean Utility Model Registration No. 20-0110250, Korean Utility Model Registration No. 20-0161333, Korean Utility Model Laid-Open Publication No. 20-1998-024295, Korean Patent Registration No. 10-0851863, Korean Utility Model Registration No. 20-0139651, Korean Utility Model Registration No. 20-0139650, and so on.

Among these, Korean Utility Model Laid-Open Publication No. 20-2000-0012181, Korean Patent Laid-Open Publication No. 10-2001-0068093, Korean Utility Model Registration No. 20-0300112, Korean Utility Model Registration No. 20-0238671, and Korean Utility Model Laid-Open Publication No. 20-1998-024167 are to accommodate a foot rest in the front passenger seat dashboard and to take out and use the foot rest as needed to provide the passenger with a comfortable feeling during the passenger's rest.

Such suggestions are to provide a comfortable rest for the passenger by the installed foot rest or leg rest, but there are still necessary to develop the foot or leg rest.

### SUMMARY OF THE INVENTION

The prior arts as described above are to provide a comfortable rest for the passenger by means of the configuration to add a foot rest or leg rest into a conventional automobile interior structure. Such an additional composition can provide the passenger with a comfortable rest, but the effects are restrictive. In other words, the passenger sitting on the front passenger seat cannot stretch out her or his legs horizontally and completely. Such a restriction is derived from the limit that the conventional automobile interior structure cannot accommodate a sufficient space to provide a sufficiently comfortable rest for the passenger.

So, the present invention is devised to overcome the restriction of the prior arts as described above. Therefore, it is an object of the present invention to provide an interior structure of automobile having a leg rest at the front passenger seat in which a sufficient space is obtained in front of the front passenger seat by substantially removing the front passenger seat dashboard conventionally provided in front of the front passenger seat and a leg rest is installed in the obtained space to provide more enhanced comfortable rest for the passenger when she or he take a rest.

To accomplish these and other objects, the present invention provides an interior structure of automobile having a leg rest at the front passenger seat comprising: a driver seat and a front passenger seat disposed in a line in the vertical direction (hereinafter, as referred to ‘the width direction’) for the length direction of an automobile (hereinafter, as referred to ‘the length direction’); as things disposed between the partition separating the interior room of the automobile from the engine room of the automobile and the driver seat and between the partition and the front passenger seat, a driver seat dashboard which is installed with instruments necessary for driving and disposed in front of the driver seat, a center fascia, which disposed in front of the space between the driver seat and the front passenger seat, with control panels of audio and air conditioner, and is formed in a body with the driver seat dashboard, and a leg rest fixing body disposed in the width direction in front of the front passenger seat; and a leg rest which is fixed to the leg rest fixing body, disposed in front of the front passenger seat or to the exposed side wall of the center fascia, and is unfolded parallel to the front passenger seat, in front of the front passenger seat when it is used so that the passenger sitting on the front passenger seat put down her or his legs on the leg rest; wherein the leg rest fixing body disposed in front of the front passenger seat is thinner in its length in the length direction, namely its thickness than the thickness of the driver seat dashboard and the center fascia when it is viewed from the upper part so that the space in which the leg rest is installed and unfolded is open.

It is preferable that the interior structure shall further comprise a means for fixing the leg rest which is fixed to the leg rest fixing body or to the exposed side wall of the center fascia, in order to fix the leg rest to the leg rest fixing body or to the exposed side wall of the center fascia; a means for rotating the leg rest by which the leg rest is rotated from the leg rest fixing body or from the exposed side wall of the center fascia to unfold parallel to the front passenger seat in front of the front passenger seat; and a means for supporting the leg rest by which the leg rest may be sustained in a condition of suspending from the bottom of the automobile interior room.

It is preferable that the leg rest fixing body shall be formed in a body with the driver seat dashboard and the center fascia; an elongated wall which is elongated in the front direction from the end of the leg rest fixing body disposed in the width direction shall be further installed; and an air-outlet grille of air conditioner shall be installed on the upper area of the elongated wall.

### BRIEF DESCRIPTION OF THE DRAWINGS

FIG. 1 is a drawing for illustrating an interior structure of a conventional automobile.

FIG. 2 is a drawing for illustrating an interior structure of automobile having a leg rest at the front passenger seat in accordance with an example of the present invention, in a condition of folding the leg rest.

FIG. 3 is a drawing for illustrating a condition of unfolding the leg rest, in the interior structure of automobile as shown in FIG. 2.

FIG. 4 is a drawing for illustrating an interior structure of automobile having a leg rest at the front passenger seat in accordance with another example of the present invention.

FIG. 5 is a drawing for illustrating an interior structure of automobile having a leg rest at the front passenger seat in accordance with another example of the present invention, in a condition of folding the leg rest.

FIG. 6 is a drawing for illustrating a condition of unfolding the leg rest, in the interior structure of automobile as shown in FIG. 5.

FIG. 7 is a drawing for illustrating an interior structure of automobile having a leg rest at the front passenger seat in accordance with another example of the present invention, in a condition of unfolding the leg rest.

### DETAILED DESCRIPTION OF THE INVENTION

A more complete appreciation of the invention, and many of the attendant advantages thereof, will be better appreciated by reference to the following detailed description in conjunction with accompanying drawings.

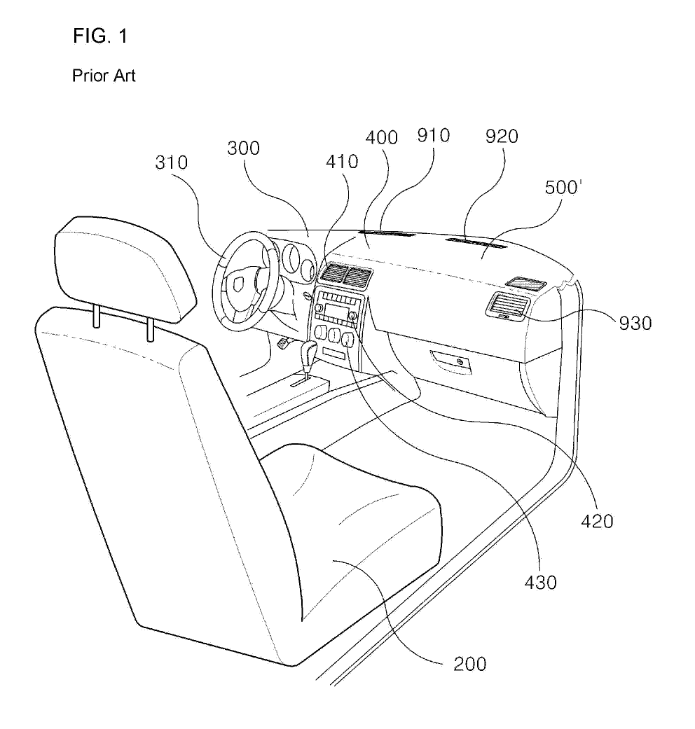

FIG. 1 is a drawing for illustrating an interior structure of a conventional automobile. Before explaining the present invention, an interior structure of a conventional automobile will be explained as follows:

The interior structure of the conventional automobile comprises a driver seat (not shown) and a front passenger seat 200 disposed in a line in the vertical direction (hereinafter, as referred to ‘the width direction’) for the length direction of an automobile (hereinafter, as referred to ‘the length direction’). A partition (not shown) is formed to separate the engine room from the interior room of the automobile. A dashboard is installed between the partition and the driver seat and between the partition and the front passenger seat, namely in front of the driver seat and the front passenger seat. The dashboard is divided into a driver seat dashboard 300, a front passenger seat dashboard 500′ and a center fascia 400 which is positioned between the driver seat dashboard and the front passenger seat, and they are formed in a body. In the driver dashboard 300, several instruments which show information necessary for driving are installed and a steering wheel 310 to control the direction of the automobile is also installed. In the driver dashboard 300, an air-outlet grille 910 of the air conditioner is also installed conventionally. In the center fascia 400, an air conditioner control panel 420 and audio and radio control panel 430 are installed, and two air-outlet grilles 410 of the air conditioner are also installed conventionally. In the front passenger seat dashboard 500′, a globe box which conventionally accommodates goods and commodities is installed and air-outlet grilles 920 and 930 of the air conditioner are also installed. Appropriate spaces in which the legs and feet of the driver and the front passenger are positioned are formed under the driver seat dashboard 300 and the front passenger seat dashboard 500′, and the center fascia 400 plays a role of separating such spaces. Therefore the dashboard is in a form of T-shape when it is totally viewed from the rear, and it is mostly uniform in an entire in the length direction of the automobile, namely in its thickness when it is viewed from the upper although it is different in accordance with the kinds of automobile. The thickness of the dashboard is mostly in a range of 25 to 40 cm although it is different in accordance with the kinds of automobile. The dashboard is conventionally made of synthetic resins.

Such an interior structure of conventional automobile was a restriction that it could not obtain a sufficient space to provide the driver and the passenger with a sufficiently comfortable rest. This inventor has recognized that several suggestions about foot rests and leg rests in front of the front passenger seat has been applied, but the reason that such suggestions could not provide sufficiently and satisfactorily comfortable rests was that they have only focused on the addition of foot rests and leg rests in front of the front passenger seat without absolutely or substantially changing the interior structure of conventional automobile. Based on this recognition, this inventor understood the fact that if the front passenger seat dashboard is substantially removed, then a space to install a leg rest providing more comfortable rest is obtained, and so reached to this invention. Therefore, the present invention is to provide more enhanced comfortable rest when the front passenger takes a rest, by means of substantially removing the front passenger seat dashboard installed in front of the front passenger seat to obtain a sufficient space for the front passenger to stretch out her or his legs horizontally and to install a leg rest in the obtained space.

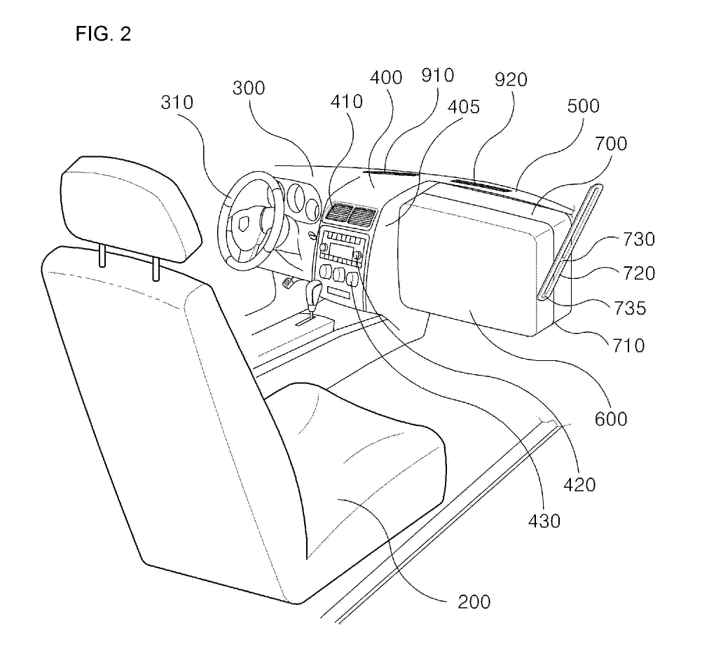

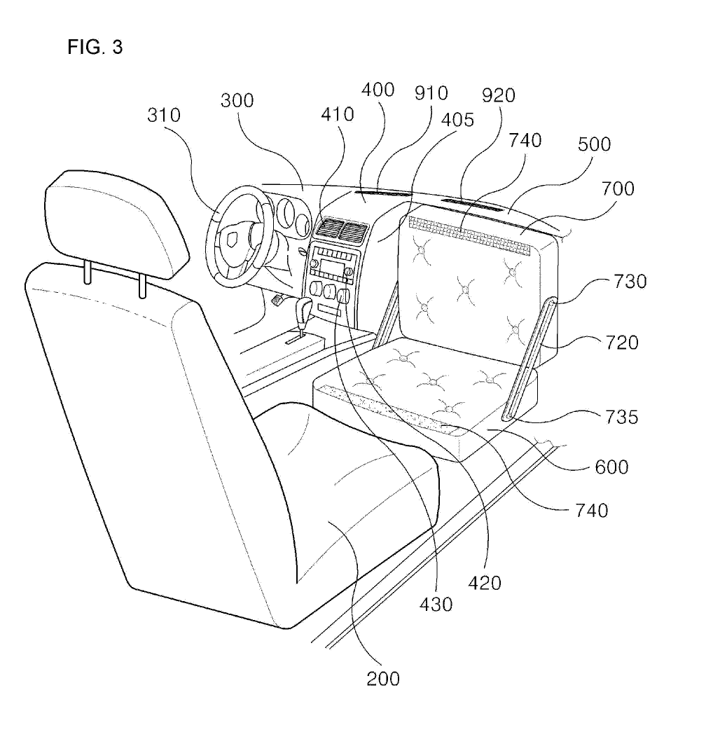

Now, the present invention will be explained in more details. FIG. 2 is a drawing for illustrating an interior structure of automobile having a leg rest at the front passenger seat in accordance with an example of the present invention, in a condition of folding the leg rest. FIG. 3 is a drawing for illustrating a condition of unfolding the leg rest, in the interior structure of automobile as shown in FIG. 2.

At first, referring to FIGS. 2 and 3, the interior structure of an automobile in accordance with the present invention includes a drive seat and a front passenger seat 200 disposed in a line in the width direction. The automobile interior structure of the present invention includes a partition separating the engine room of the automobile from the interior room of the automobile, and also includes a driver seat dashboard 300 and a center fascia 400 between the partition and the driver seat and between the partition and the space between the driver seat and the front passenger seat. Such driver seat dashboard 300 and center fascia 400 have a structure same as those of a conventional automobile. However, the automobile interior structure of the present invention does not substantially include the front passenger seat dashboard 500′, as different from the conventional automobile interior structure, but only includes a leg rest fixing body 500 in the width direction in front of the front passenger seat 200.

In more detail, the leg rest fixing body 500 in the present invention is, as different from the front passenger seat dashboard 500′ formed in the conventional automobile interior structure, considerably smaller in the length in the length direction, namely, in its thickness than the thickness of the driver seat dashboard 300 and the center fascia 400 when it is viewed from the upper. Therefore, as shown in FIGS. 2 and 3, the leg rest fixing body 500 is formed in a thickness so as to form an air-outlet grille 920 of the air conditioner with a long length in the width direction on its upper surface so that the automobile passenger may feel that there is no dashboard in front of the front passenger seat. It is for example, appropriate that the thickness of the leg rest fixing body 500 is 5 to 10 cm. The leg rest fixing body 500 is not limited to a special type, if it can fix a leg rest, as explained below. For example, the leg rest fixing body 500 may be a plate type to be arranged with a little gap after the partition. In this case, the ducts and the electric wires of the air conditioner may be arranged in the space between the partition and the leg rest fixing body 500. The leg rest fixing body 500 may also be two circular or rectangular type bars in the upper and the lower positions across the width direction with a little gap after the partition. Such circular or rectangular type bars may be fixed to the partition, or to the center fascia and the car frame at the sides. The leg rest fixing body 500 may also be, as a hollow plate type, formed in a body with the driver seat dashboard 300 and the center fascia 400.

A considerably large space is formed between the front passenger seat 200 and the leg rest fixing body 500, due to the leg rest fixing body 500 formed in the width direction instead of the front passenger seat dashboard, and such a space is opened. A leg rest 600 is installed such an opened space.

The leg rest 600 is installed to be fixed to the leg rest fixing body 500. Alternatively, the leg rest 600 may be installed to the exposed side wall 405 of the center fascia 400. To install the leg rest 600 to the leg rest fixing body 500 and to install it to the exposed side wall 405 of the center fascia 400 are different in the size of the leg rest 600 to be installed, but are performed in accordance with the same principle. Therefore, to install it to the leg rest fixing body 500 will be only explained below. The leg rest 600 is to be unfolded parallel to the front passenger seat 200 in front of the front passenger seat 200 when it is fixed to the leg rest fixing body 500 or the exposed side wall 405 and is used.

In order to fix the leg rest 600 to the leg rest fixing body 500, the automobile interior structure of the present invention may include a leg rest connecting plate 700 as an example of a leg rest fixing means, a folding means 710 as an example of a leg rest rotating means to make the leg rest 600 rotate from the leg rest fixing body 500 to be unfolded parallel to the front passenger seat 200 in front of the front passenger seat 200, and a leg rest supporting guide 720 as an example of a leg rest supporting means to keep the leg rest 600 to suspend from the automobile interior bottom.

The leg rest connecting plate 700 is as a rectangular type plate, fixed to the leg rest fixing body 500. A conventionally known and used fixing means may be used as a means for fixing the leg rest connecting plate 700 to the leg rest fixing body 500. Such an example may include connecting by screws, connecting by strong adhesives and so on.

The leg rest 600 is in a rotatable or pivotable manner, connected to the leg rest connecting plate 700. A conventionally applied folding means 710 may be used for forming the pivotable connecting. The folding means 710 may be a strip to fold and to connect the leg rest connecting plate 700 and the leg rest 600, and by this folding means 710, the rotating may be performed by the activity of the gravity due to the weight of the leg rest. The folding means 710 may also be a cover which has a part to be folded in its middle area, a leg rest connecting plate cover part to accommodate the leg rest connecting plate in one area, and a leg rest cover part to accommodate the leg rest in the opposite area.

The rotatable connection may be performed by several other means such as hinge means other than the folding means. For example, the leg rest connecting plate 700 and the leg rest 600 may be connected by means of folding tools for hinge-connecting or folding, and the rotation may be performed by the activity of the gravity due to the weight of the leg rest.

For the leg rest 600 to be folded to the leg rest connecting plate 700 when it is not used, a leg rest folding fixing means 740 is installed to the upper surfaces of the leg rest connecting plate 700 and the leg rest 600. As the leg rest folding fixing means 740, velcro adhesive fabrics may be used as the simplest thing, and other connection means may also be used.

It is preferable that the leg rest 600 shall be arranged parallel continuously to the front passenger seat 200 in front of the front passenger seat 200 when it is unfolded, but although there is a little difference of floor level between them and the leg rest 600 is a little distant from the front passenger seat, such things may not bring out substantial uncomfortable things in use. For the leg rest 600 to be arranged horizontally and continuously to the front passenger seat 200 when it is unfolded, the leg rest 600 shall suspend from the automobile interior bottom. For the leg rest 600 to be kept in this state, a leg rest supporting means is needed. A leg rest supporting guide 720 may be used as an example of such a leg rest supporting means.

For example, the leg res supporting guide 720 is a long plate type member with a long groove or hole in its length direction. Two hanging bumps 730 are mounted on appropriate positions of the sides of the leg rest connecting plate 700, and two hanging bumps 735 are also mounted on appropriate positions of the sides of the leg rest 600. The hanging bumps 730 and 735 are inserted in the holes of a pair of the leg rest supporting guide 720 so that a pair of the leg rest supporting guide 720 may be installed between the leg rest 600 and the leg rest connecting plate 700. At this time, one of the hanging bumps 730 and 735 may be fixed to the leg rest supporting guide 720 or the leg rest supporting guide 720 may be installed to be moved respectively for both of the hanging bumps 730 and 735.

As shown in FIG. 3, the leg rest supporting guide 720 installed in this manner makes the leg rest 600 hang up at the hanging bumps 730 and 735 when it is completely unfolded and thus make it not to be rotated to the lower any more so that the leg rest 600 may be kept to suspend from the automobile interior bottom. While, when the leg rest 600 is rotated and folded to the upper, then as shown in FIG. 2, one or both of the hanging bumps 730 and 735 are respectively moved through the hole of the leg rest supporting guide 720 so that the leg rest 600 may be folded to the leg rest connecting plate 700.

As a leg rest supporting means used instead of the leg rest supporting guide, a plurality of legs having a structure for folding and unfolding under the leg rest 600 may be used. Such a leg may be to be often applied to the Korean table in which its legs can be folded.

The leg rest 600 is a means on which the front passenger put down her or his legs, so it is preferable that it shall be formed with a cushion material. It is also preferable that the leg rest connecting plate 700 shall be made of a cushion material.

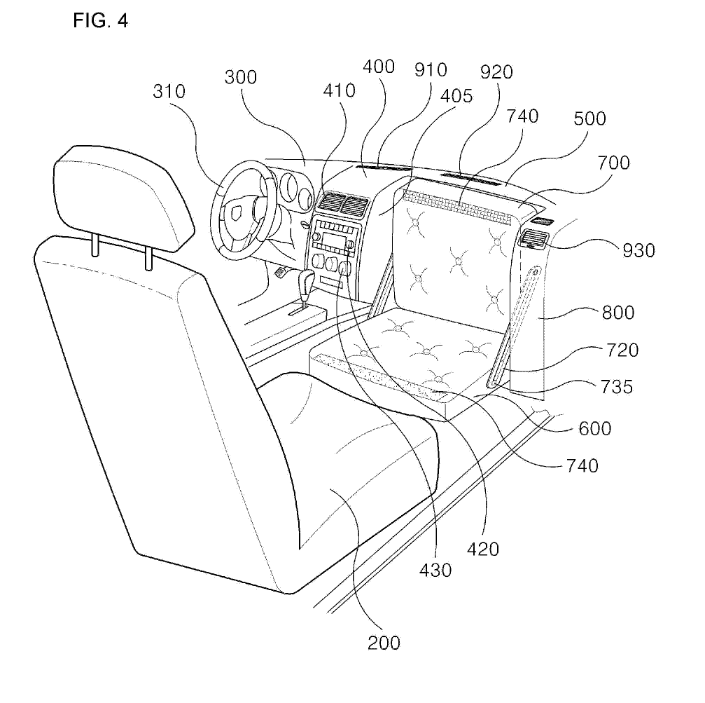

The leg rest fixing body 500 as described above may bring out the shortage in the air amount supplied by the air conditioner to the front passenger seat, which may give the front passenger an inconvenience. To prevent this, FIG. 4 shows an interior structure of automobile having the front passenger seat leg rest in accordance with another example of the present invention. According to the example as shown in FIG. 4, an elongated wall 800 which is elongated in the forward direction from the end of the leg rest fixing body 500 arranged in the width direction is further installed. An air-outlet grille 930 of the air conditioner is installed on the upper surface of the elongated wall 800. The air-outlet grille 930 of the air conditioner can provide air blast of the air conditioner to the front passenger seat in addition to the air-outlet grille 920 of the air conditioner; therefore the front passenger may feel comfortable. The elongated wall 800 additionally installed in order to install the air-outlet grille 930 of the air conditioner is not large in its width in the width direction of the automobile; so it does not substantially restrict the opened space in which the leg rest is installed.

The facts that air-outlet ducts for supplying air blast of the air conditioner and if needed, electric wires may be installed inside the leg rest fixing body 500 and the elongated wall 800 as well as inside the driver seat dashboard 300 and center fascia 400 will be appreciated by a person ordinarily skilled in this art.

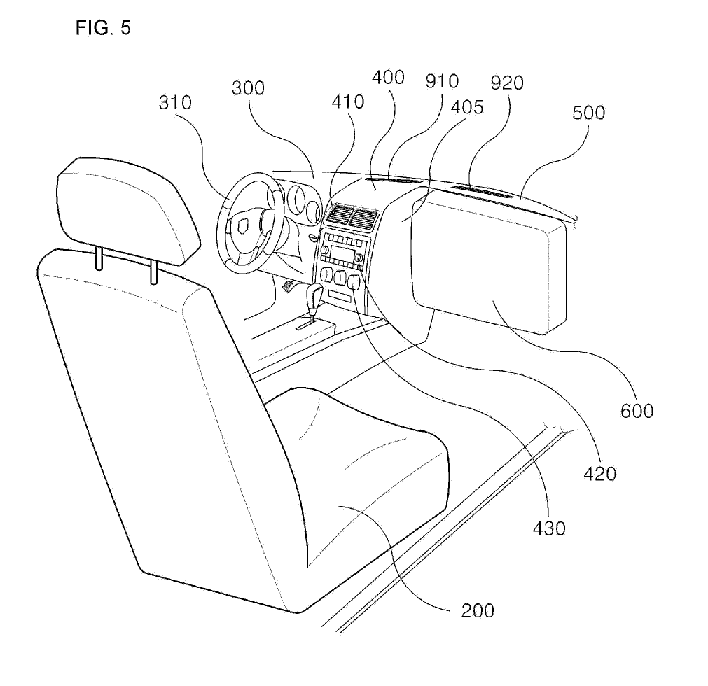

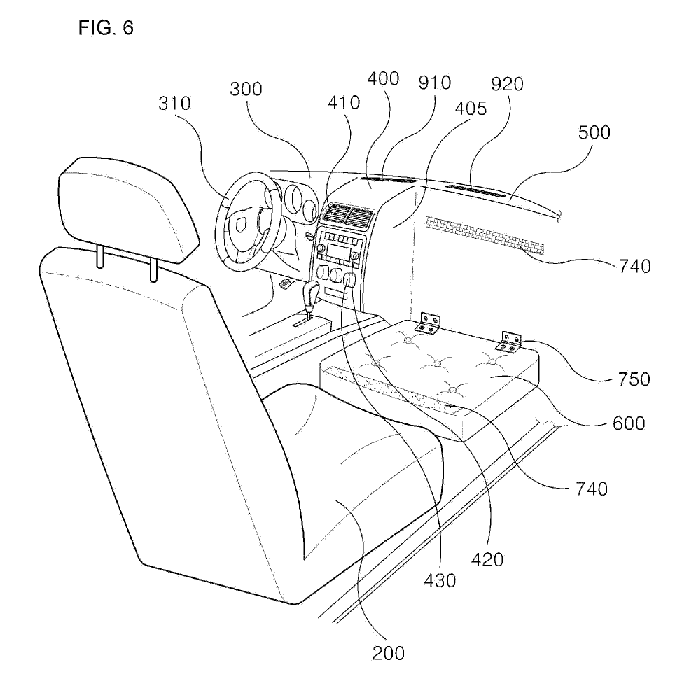

FIG. 5 is a drawing for illustrating an interior structure of automobile having a leg rest at the front passenger seat in accordance with another example of the present invention, in a condition of folding the leg rest. FIG. 6 is a drawing for illustrating a condition of unfolding the leg rest, in the interior structure of automobile as shown in FIG. 5.

The example as shown in FIGS. 5 and 6 corresponds to an example in which the leg rest 600 is directly fixed to the leg rest fixing body 500. For this structure, the leg rest 600 and the leg rest fixing body 500 are connected to each other by two hinges 750 so that the leg rest 600 may be rotated for the leg rest fixing body 500. As a leg rest folding fixing means, the simplest Velcro adhesive fabrics may be used to fix the leg rest 600 to the leg rest fixing body 500 when it is folded. As not shown in the drawings, to keep the leg rest 600 to suspend from the automobile interior bottom, the leg rest supporting means may be connected between the leg rest fixing body 500 and the leg rest 600 to support the leg rest. The leg rest supporting means may also be applied as a leg shape for the leg rest 600 under it.

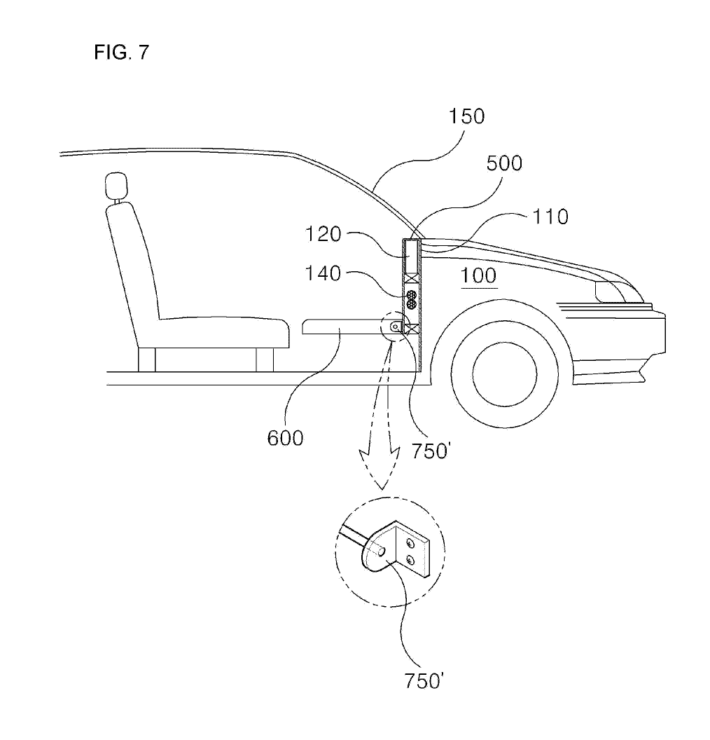

FIG. 7 is a drawing for illustrating an interior structure of automobile having a leg rest at the front passenger seat in accordance with another example of the present invention, in a condition of unfolding the leg rest. As shown in FIG. 7, the partition 110 separating the engine room 100 from the automobile interior room is formed after the engine room and the leg rest fixing body 500 is arranged in a certain distance of gap after the partition 110. A pathway through which ducts 120 for ventilation and electric wires 140 go is provided between the partition 110 and the leg rest fixing body 500. The leg rest 600 is connected in a rotatable or pivotable manner to the leg rest fixing body 500 by the hinge means 750′ which is connected to the leg rest fixing body 500. In this case, the leg rest 600 may be supported by the hinge means 750′ when it is unfolded, and it may be supported by a separate leg rest supporting means such as a leg shape when supporting force is more needed.

1. An interior structure of automobile having a leg rest at the front passenger seat comprising: a driver seat and a front passenger seat disposed in a line in a vertical direction (hereinafter, as referred to ‘the width direction’) for the length direction of an automobile (hereinafter, as referred to ‘the length direction’); as things disposed between a partition separating the engine room of the automobile from the interior room of the automobile and the driver seat and between the partition and the front passenger seat, a driver seat dashboard which is disposed in front of the driver seat, a center fascia, which disposed in front of the space between the driver seat and the front passenger seat, with control panels of audio and air conditioner, and is formed in a body with the driver seat dashboard, and a leg rest fixing body disposed in the width direction in front of the front passenger seat; and a leg rest which is fixed to the leg rest fixing body disposed in front of the front passenger seat or to the exposed side wall of the center fascia, and is unfolded parallel to the front passenger seat in front of the front passenger seat when it is used so that the passenger sitting on the front passenger seat put down her or his legs on the leg rest; wherein a front passenger seat dashboard is not disposed in front of the front passenger seat in the interior structure of automobile, the leg rest fixing body disposed in front of the front passenger seat is thinner in its length of the length direction, namely its thickness than the thickness of the driver seat dashboard and the center fascia when it is viewed from the upper part so that the space in which the leg rest is installed and unfolded is open upward.

2. The interior structure of automobile having a leg rest at the front passenger seat as set forth in claim 1, wherein the interior structure further comprises a means for fixing the leg rest which is fixed to the leg rest fixing body or to the exposed side wall of the center fascia, in order to fix the leg rest to the leg rest fixing body or to the exposed side wall of the center fascia; a means for rotating the leg rest by which the leg rest is rotated from the leg rest fixing body or from the exposed side wall of the center fascia to unfold parallel to the front passenger seat in front of the front passenger seat; and a means for supporting the leg rest by which the leg rest may be kept in a condition of suspending from the bottom of the automobile interior room.

3. The interior structure of automobile having a leg rest at the front passenger seat as set forth in claim 2, wherein the leg rest fixing body is formed in a body with the driver seat dashboard and the center fascia; an elongated wall which is elongated in the front direction from the end of the leg rest fixing body disposed in the width direction is further installed; and an air-outlet grille of the air conditioner is installed on the upper area of the elongated wall.
